(19) United States
(12) Patent Application Publication
(10) Pub. No.: US 2020/0149722 A1
(43) Pub. Date: May 14, 2020

(54) METHOD AND DEVICE FOR DECORATIVE LIGHT DISPLAY

(71) Applicant: Eric Green, Brookshire, TX (US)

(72) Inventor: Eric Green, Brookshire, TX (US)

(21) Appl. No.: 16/186,745

(22) Filed: Nov. 12, 2018

(51) Int. Cl. F21V 21/34; F21V 21/08; F21S 4/10

(52) U.S. Cl. CPC F21V 21/34; F21W 2121/00; F21S 4/10; F21V 21/0832

(57) ABSTRACT

A lighting arrangement that includes: a first elongated connector; a second elongated connector; a string of lights engaged between the first elongated connector and second elongated connector; and a plurality of tie connectors adapted to attach the string of lights to each respective elongated connector. The lighting arrangement further includes a series of openings along the length of each elongated connector, wherein each elongated connector includes at least one a hook and loop connector for attachment purposes.

### BACKGROUND OF THE INVENTION

### Field of Invention

The present invention relates to a device used to create a lighting arrangement for decorative purposes.

### Description of Related Art

Many individuals and businesses use decorative lighting for display purposes, especially during the holiday times of the year. Individuals and businesses display lights to create a festive holiday environment. Hanging decorative lights usually involves the placement of a string of lights over a flat surface, around a window or in other prominent areas as desired. The hanging of lights can be somewhat tedious due to the necessity for the insertion of connectors or placement of nails or tacks to place the lights in a stationary position. As a result, it would be advantageous to have a lighting assembly that is available for easy placement over a particular surface and to more efficiently facilitate the placement of lighting.

### SUMMARY OF THE INVENTION

The present invention relates to a lighting arrangement that includes: a first elongated connector; a second elongated connector; a string of lights engaged between the first elongated connector and second elongated connector; and a plurality of tie connectors adapted to attach the string of lights to each respective elongated connector. The lighting arrangement further includes a series of openings along the length of each elongated connector, wherein each elongated connector includes at least one a hook and loop connector for attachment purposes.

### BRIEF DESCRIPTION OF DRAWINGS

FIG. 1 depicts a lighting arrangement according to the present invention.

FIG. 2 depicts a second embodiment of the lighting arrangement according to the present invention.

FIG. 3 depicts a third embodiment of the lighting arrangement according to the present invention.

### DETAILED DESCRIPTION

The present invention relates to a lighting arrangement that includes two elongated connectors that have a series of openings that receive tie connectors that facilitate the placement of a string of lights between the elongated connectors. Once the string of lights are attached to the elongated connectors these connectors can be then used to place the string of lights on a object or building. The elongated connectors further include hook and loop connectors that are used to join the elongated connectors to place the lighting arrangement into a stationary position.

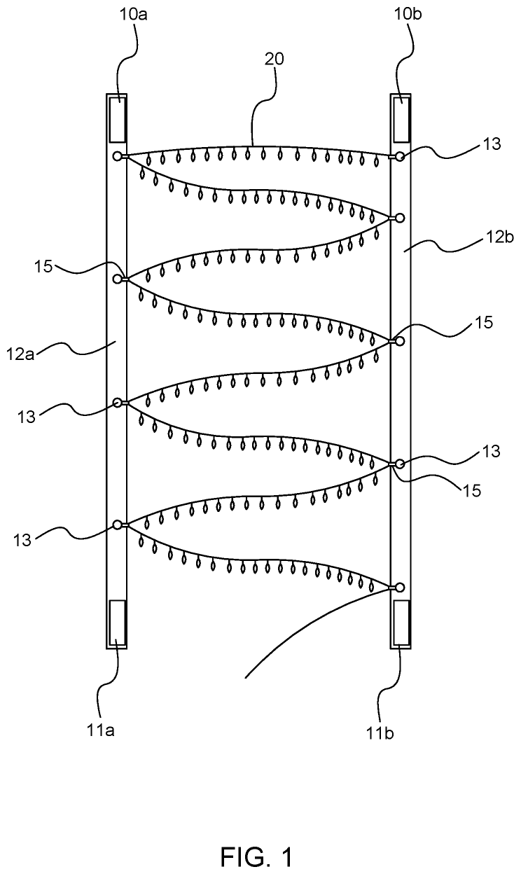

In reference to FIG. 1, a lighting arrangement according to the present invention is depicted. This lighting arrangement includes a first elongated connector 12a and a second elongated connector 12b. As can be seen in the FIG. 1, a string of lights 20 is engaged between the elongated connectors 12a, 12b, where the lights 20 are attached to each connector using tie connectors 15. The tie connectors 15 loop into openings 13 that are provided along the length of each respective elongated connector 12a, 12b. The lighting arrangement may display various patterns, sequencing and color arrangements.

The elongated connectors 12a, 12b both include hook and loop connectors 10a, 10b and further hook and loop connectors 11a, 11b. These hook and loop connectors 11a, 11b are used to engage the first elongated connector 12a together with the second elongated connector 12b for placement over an object. Further the hook and loop connectors may be engaged with other adjoining hook and loop connector arrangements for placement onto a building or structure.

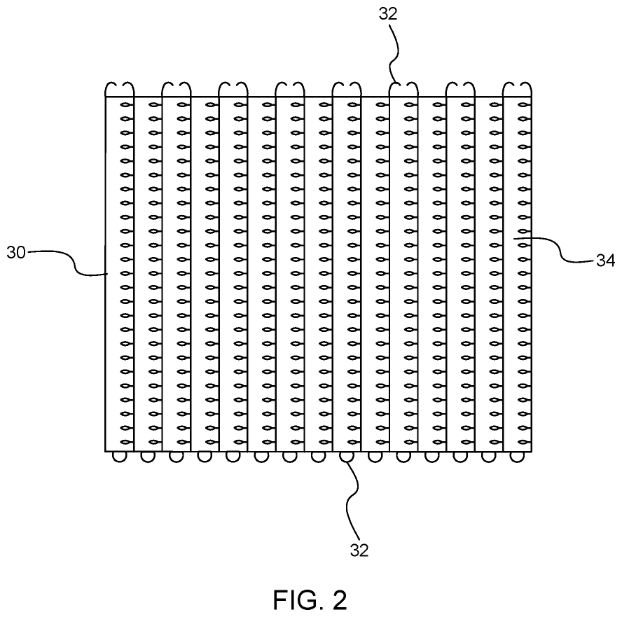

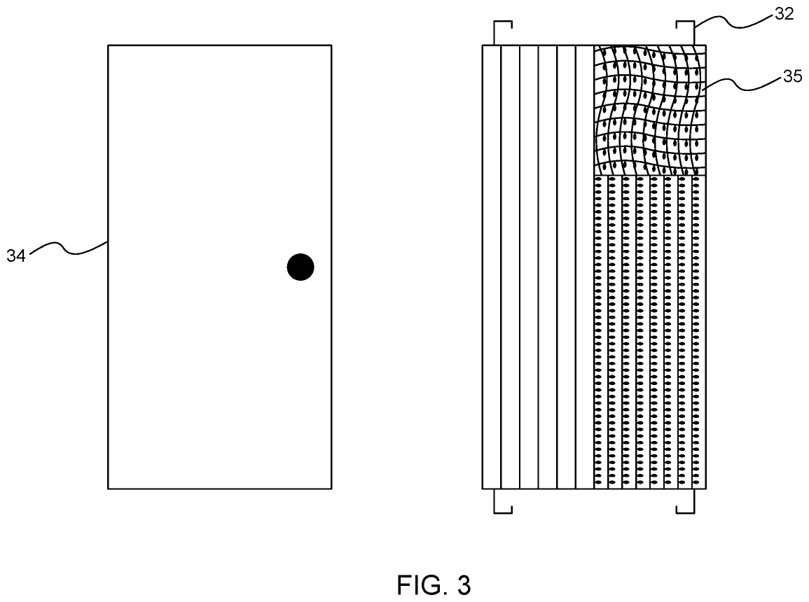

The present invention creates an exemplary lighting arrangement as shown in FIG. 1. This lighting arrangement provides a unique method of assembling a string of lights for display purposes. FIG. 2 shows an alternative embodiment of the present invention. A lighting arrangement 30 is shown on door 34. This particular lighting arrangement 30 includes a plurality of hooks 32 that attach the lighting arrangement 30 onto the door 34. The hooks 32 with the line over the top edge of the door and along the bottom edge of the door. The hooks 32 are designed to secure the lighting arrangement 30 into place to enable the opening and closing of the door. The hooks 32 are U-shaped with a flat surface along the door seal. Further, FIG. 3 shows yet another lighting arrangement 35 has placed over door 34. The door 34 is shown without lighting arrangement 35 placed thereon in FIG. 3A. FIG. 3B shows the lighting arrangement 35 attached to the door 34 with hooks 32. In this particular embodiment, four hooks are used to secure the lighting arrangement 35 in place. The hooks 32 include two hooks at the top of door 34 and two other hooks are attached at the lower portion for door 34. This arrangement 35 provides less elements as opposed to the arrangement of FIG. 2. The lighting arrangement may depict any exemplary design as shown in FIG. 3, where the lighting arrangement 35 resembles a flag. Other lighting arrangements may include the display of sporting team logos, other related holidays and so forth.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use

1. A lighting arrangement comprising:
a first flat elongated connector, wherein the first elongated connector includes a first hook and loop connector at a first end and a second hook and loop connector at a second end;
a second flat elongated connector, wherein the second elongated connector includes a third hook and loop connector at a first end and a forth hook and loop connector at a second end;
a string of lights engaged between the first elongated connector and second elongated connector; and
a plurality of tie connectors adapted to attach the string of lights to each respective elongated connector.

2. The lighting arrangement according to claim 1 further including a series of openings along the length of each elongated connector.

3. (canceled)
